(19) United States
(12) Patent Application Publication
(10) Pub. No.: US 2025/0068936 A1
(43) Pub. Date: Feb. 27, 2025

(54) Informed Machine Learning For Cement Bond Evaluation

(71) Applicant: Halliburton Energy Services, Inc., Houston, TX (US)

(72) Inventors: Brenno Caetano Troca Cabella, Rio de Janeiro (BR); Ruijia Wang, Singapore (SG); Yao Ge, Singapore (SG); Frederico Heloui de Araujo, Rio de Janeiro (BR); Otto Fanini, Houston, TX (US); Xiang Wu, Singapore (SG)

(73) Assignee: Halliburton Energy Services, Inc., Houston, TX (US)

(21) Appl. No.: 18/236,613

(22) Filed: Aug. 22, 2023

(51) Int. Cl. G06N 5/02; G06F 17/18

(52) U.S. Cl. CPC G06N 5/02; G06F 17/18

(57) ABSTRACT

A method for forming an informed machine learning model. The method may include providing one or more inputs to an information handling system, adjusting the one or more inputs with one or more knowledge based features on the information handling system, and selecting one or more features from the one or more inputs by weighting informed features with the information handling system. The method may further include forming a training process from the one or more features selected by utilizing an informed loss function with the information handling system and forming an informed machine learning model that is used by the information handling system.

### BACKGROUND

The oil and gas industry may use wellbores as fluid conduits to access subterranean deposits of various fluids and minerals which may include hydrocarbons. A drilling operation may be utilized to construct wellbores which are capable of producing hydrocarbons disposed in subterranean formations. At the end of a wellbore's life, the wellbore is plugged and abandoned.

During the Plug and Abandonment (P&A) process, a zone within the wellbore that has a good cement barrier to set the plug is identified. Many methods have been proposed to evaluate cement bond conditions, including machine learning (ML), where the complexity of the interactions is examined within a data-driven approach. A significant limitation of machine learning use is the dependence on available data. The result from a ML may only be as good as the data quality to train the algorithms. For small data sets, it is possible to obtain spurious relations and compromise the model's generalization capability. In cement bond evaluation, the variability of scenarios due to differences in borehole characteristics may hinder the needed data size. Further, the data may become obsolete due to changing reservoir conditions.

On the other hand, physics-based models are limited in extracting knowledge directly from data and primarily rely only on the available physics. For example, many physics-based models use parameterized forms of approximations for representing complex physical processes that are either not fully understood or cannot be solved using computationally tractable methods. Calibrating the parameters in physics-based models is a challenging task because of the combinatorial nature of the search space. There is a need to identify cement bond conditions from reduced data sets and physics-based models.

### BRIEF DESCRIPTION OF THE DRAWINGS

These drawings illustrate certain aspects of some examples of the present disclosure and should not be used to limit or define the disclosure.

FIG. 1 illustrates an example of a drilling system and operation;

FIG. 2 illustrates is a schematic view of an information handling system;

FIG. 3 illustrates another schematic view of and information handling system;

FIG. 4 illustrates a schematic view of a network;

FIG. 5 illustrates a schematic of a machine learning algorithm which may be used for deep learning;

FIG. 6 illustrates a workflow for an informed machine learning algorithm; and

FIG. 7 illustrates data-driven and knowledge-based approaches may be adjusted according to the available data set and prior knowledge.

### DETAILED DESCRIPTION

Systems and methods described below may utilize an integration of incorporating prior knowledge into the ML process. Hence, the notion of informed machine learning. Generally, machine learning (ML) processes involve the usual training data and additional knowledge such as logic rules, simulation results, physics principles, and/or the like. However, the systems and methods described below for an informed machine learning process may utilize prior knowledge that is explicitly integrated into the informed machine learning workflow through interfaces defined by the knowledge representations.

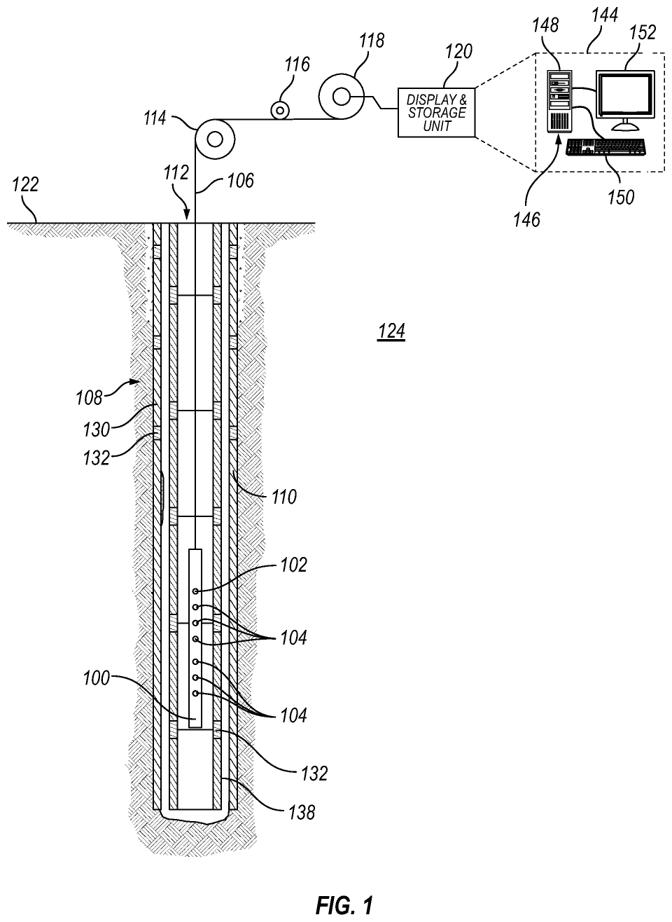

FIG. 1 illustrates an operating environment for an acoustic logging tool 100 as disclosed herein. As illustrated, acoustic logging tool 100 is disposed within wellbore 110, which is disposed within formation 124. Acoustic logging tool 100 may comprise a transmitter 102 and/or a receiver 104. Additionally, transmitter 102 and receiver 104 may be configured to rotate in acoustic logging tool 100. In examples, there may be any number of transmitters 102 and/or any number of receivers 104, which may be disponed on acoustic logging tool 100. Additionally, transmitter 102 and receiver 104 may be configured to rotate in acoustic logging tool 100. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within conduit string 108 to a desired depth within wellbore 110. In examples, tubing may be concentric in the casing, however in other examples the tubing may not be concentric Conveyance 106, which may include one or more electrical conductors, may exit wellhead 112, may pass around pulley 114, may engage odometer 116, and may be reeled onto winch 118, which may be employed to raise and lower the tool assembly in the wellbore 110. Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and stored for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical conduit string 108 may extend from wellhead 112 at or above ground level to a selected depth within a wellbore 110. Conduit string 108 may comprise a plurality of joints 130 or segments of conduit string 108, each joint 130 being connected to the adjacent segments by a collar 132. Additionally, conduit string 108 may include a plurality of tubing.

FIG. 1 also illustrates inner conduit string 108, which may be positioned inside of conduit string 108 extending part of the distance down wellbore 110. Inner conduit string 108 may be production tubing, tubing string, conduit string, or other pipe disposed within conduit string 108. Inner conduit string 108 may comprise concentric pipes. It should be noted that concentric pipes may be connected by collars 132. Acoustic logging tool 100 may be dimensioned so that it may be lowered into the wellbore 110 through inner conduit string 108, thus avoiding the difficulty and expense associated with pulling inner conduit string 108 out of wellbore 110. Herein conduit string 108 may be comprised of inner conduit string 138.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to surface 122 during logging (corrosion detection).

Acoustic logging tool 100 may be used for excitation of transmitter 102. As illustrated, one or more receivers 104 may be positioned on the acoustic logging tool 100 at selected distances (e.g., axial spacing) away from transmitter 102. The axial spacing of receiver 104 from transmitter 102 may vary, for example, from about 0 inches (0 cm) to about 40 inches (101.6 cm) or more. In some embodiments, at least one receiver 104 may be placed near the transmitter 102 (e.g., within at least 1 inch (2.5 cm) while one or more additional receivers may be spaced from 1 foot (30.5 cm) to about 5 feet (152 cm) or more from the transmitter 102. It should be understood that the configuration of acoustic logging tool 100 shown on FIG. 1 is merely illustrative and other configurations of acoustic logging tool 100 may be used with the present techniques. In addition, acoustic logging tool 100 may include more than one transmitter 102 and more than one receiver 104. For example, an array of receivers 104 may be used. Transmitters 102 may include any suitable acoustic source for generating acoustic waves downhole, including, but not limited to, monopole and multipole sources (e.g., dipole, cross-dipole, quadrupole, hexapole, or higher order multi-pole transmitters). Additionally, one or more transmitters 102 (which may include segmented transmitters) may be combined to excite a mode corresponding to an irregular/arbitrary mode shape. Specific examples of suitable transmitters 102 may include, but are not limited to, piezoelectric elements, bender bars, or other transducers suitable for generating acoustic waves downhole. Receiver 104 may include any suitable acoustic receiver suitable for use downhole, including piezoelectric elements that may convert acoustic waves into an electric signal.

Systems and methods of the present disclosure may be implemented and/or controlled by display and storage unit 120, which may include an information handling system 144. As illustrated, the information handling system 144 may be a component of the display and storage unit 120. Alternatively, the information handling system 144 may be a component of acoustic logging tool 100. An information handling system 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may include a processing unit 146 (e.g., microprocessor, central processing unit, etc.) that may process EM log data by executing software or instructions obtained from a local non-transitory computer readable media 148 (e.g., optical disks, magnetic disks). Non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis results, and/or perform other tasks.

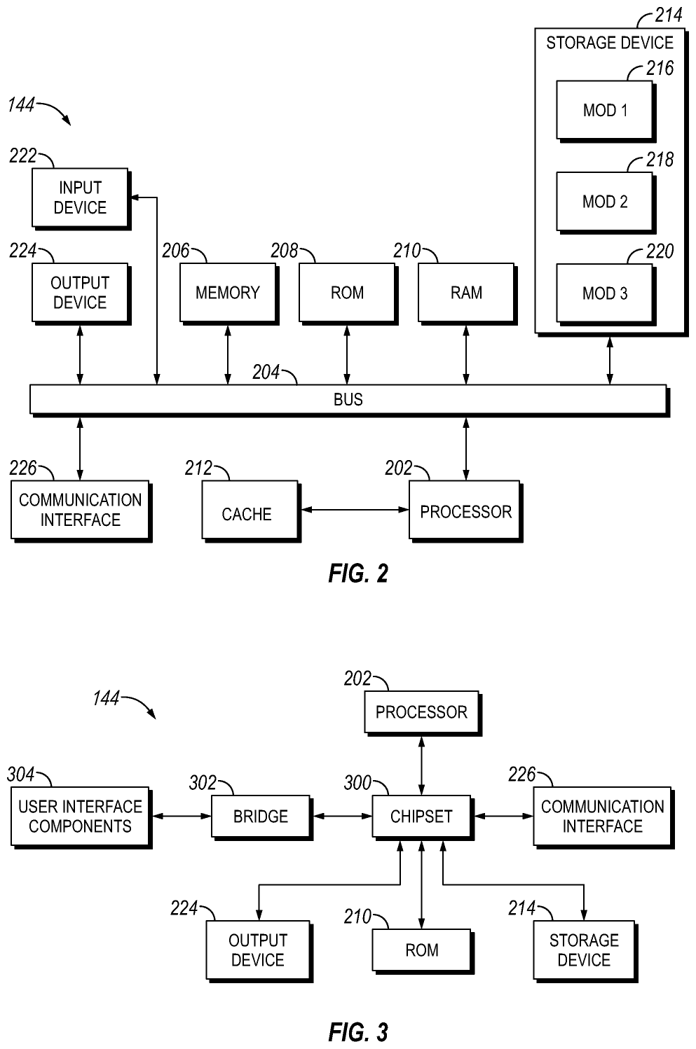

FIG. 2 illustrates an example information handling system 144 which may be employed to perform various steps, methods, and techniques disclosed herein. Persons of ordinary skill in the art will readily appreciate that other system examples are possible. As illustrated, information handling system 144 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 144 may include a cache 212 of high-speed memory connected directly with, in close proximity to, or integrated as part of processor 202. Information handling system 144 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. System memory 206 may be available for use as well. Memory 206 may include multiple different types of memory with different performance characteristics. It may be appreciated that the disclosure may operate on information handling system 144 with more than one processor 202 or on a group or cluster of computing devices networked together to provide greater processing capability. Processor 202 may include any general-purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may include multiple processors, such as a system having multiple, physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 144, such as during start-up. Information handling system 144 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 144 may include other hardware or software modules. Storage device 214 is connected to the system bus 204 by a drive interface. The drives and the associated computer-readable storage devices provide nonvolatile storage of computer-readable instructions, data structures, program modules and other data for information handling system 144. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. For example, the hybrid data generator, which may include a Large Language Model or other models derived from machine learning-and deep learning algorithms, may include computational instructions which may be executed on a processor to generate an initial and/or an updated drilling program. In some examples, the deep learning algorithms may include convolutional neural networks, long short term memory networks, recurrent neural networks, generative adversarial networks, attention neural networks, zero-shot models, fine-tuned models, domain-specific models, multi-modal models, transformer architectures, radial basis function networks, multilayer perceptrons, self-organizing maps, deep belief networks, and combinations thereof. The basic components and appropriate variations may be modified depending on the type of device, such as whether information handling system 144 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 144 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 222 represents any number of input mechanisms, such as a microphone for speech, a touch-sensitive screen for gesture or graphical input, keyboard, mouse, motion input, speech and so forth. An output device 224 may also be one or more of a number of output mechanisms known to those of skill in the art. In some instances, multimodal systems enable a user to provide multiple types of input to communicate with information handling system 144. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 208 for storing software performing the operations described below, and random-access memory (RAM) 210 for storing results. Very large-scale integration (VLSI) hardware examples, as well as custom VLSI circuitry in combination with a general-purpose DSP circuit, may also be provided.

FIG. 3 illustrates an example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. A bridge 302 for interfacing with a variety of user interface components 304 may be provided for interfacing with chipset 300. Such user interface components 304 may include a keyboard, a microphone, touch detection and processing circuitry, a pointing device, such as a mouse, and so on. In general, inputs to information handling system 144 may come from any of a variety of sources including machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 144 may receive one or more inputs from a user via user interface components 304 and execute appropriate functions, such as browsing functions by interpreting these inputs using processor 202.

In examples, information handling system 144 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

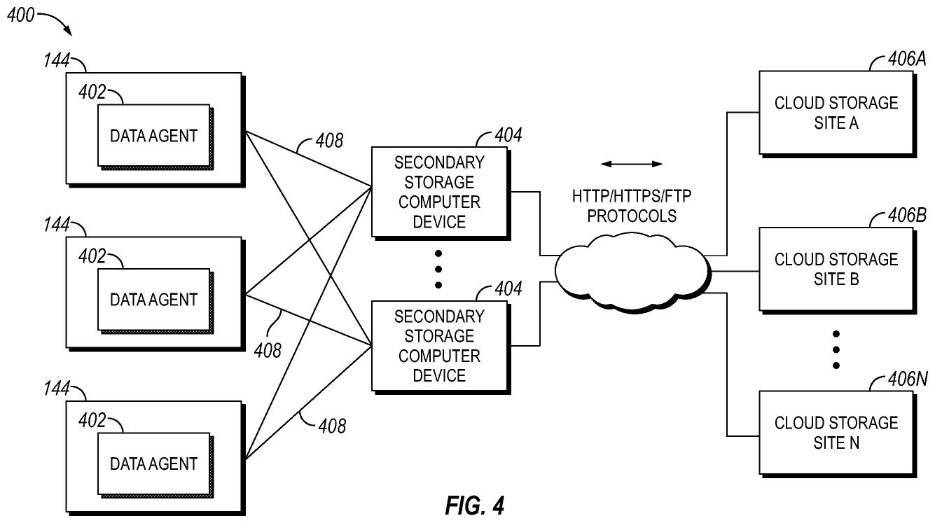

FIG. 4 illustrates an example of one arrangement of resources in a computing network 400 that may employ the processes and techniques described herein, although many others are of course possible. As noted above, an information handling system 144, as part of their function, may utilize data, which includes files, directories, metadata (e.g., access control list (ACLS) creation/edit dates associated with the data, etc.), and other data objects. The data on the information handling system 144 is typically a primary copy (e.g., a production copy). During a copy, backup, archive or other storage operation, information handling system 144 may send a copy of some data objects (or some components thereof) to a secondary storage computing device 404 by utilizing one or more data agents 402.

A data agent 402 may be a desktop application, website application, or any software-based application that is run on information handling system 144. As illustrated, information handling system 144 may be disposed at any rig site (e.g., referring to FIG. 1) or repair and manufacturing center. The data agent may communicate with a secondary storage computing device 404 using communication protocol 408 in a wired or wireless system. The communication protocol 408 may function and operate as an input to a website application. In the website application, field data related to pre-and post-operations, generated DTCs, notes, and the like may be uploaded. Additionally, information handling system 144 may utilize communication protocol 408 to access processed measurements, operations with similar DTCs, troubleshooting findings, historical run data, and/or the like. This information is accessed from secondary storage computing device 404 by data agent 402, which is loaded on information handling system 144.

Secondary storage computing device 404 may operate and function to create secondary copies of primary data objects (or some components thereof) in various cloud storage sites 406A-N. Additionally, secondary storage computing device 404 may run determinative algorithms on data uploaded from one or more information handling systems 144, discussed further below. Communications between the secondary storage computing devices 404 and cloud storage sites 406A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 406A-N, the secondary storage computing device 404 may also perform local content indexing and/or local object-level, sub-object-level or block-level deduplication when performing storage operations involving various cloud storage sites 406A-N. Cloud storage sites 406A-N may further record and maintain DTC code logs for each downhole operation or run, map DTC codes, store repair and maintenance data, store operational data, and/or provide outputs from determinative algorithms and or models that are located in cloud storage sites 406A-N. In a non-limiting example, this type of network may be utilized as a platform to store, backup, analyze, import, and perform extract, transform and load (“ETL”) processes to the data gathered during a measurement operation. In further examples, this type of network may be utilized to execute an informed machine learning model to identify zones within wellbore 110 in which a plug may be inserted to allow for abandonment of wellbore 110.

A machine learning model may be an empirically derived model which may result from a machine learning algorithm identifying one or more underlying relationships within a dataset. In comparison to a physics-based model, which may be derived from first principles and define the mathematical relationship of a system, a pure machine learning model may not be derived from first principles. Once a machine learning model is developed, it may be queried in order to predict one or more outcomes for a given set of inputs. The type of input data used to query the machine learning model to create the prediction may correlate both in category and type to the dataset from which the machine learning model was developed.

The structure of, and the data contained within a dataset provided to a machine learning algorithm may vary depending on the intended function of the resulting machine learning model. In some examples, the data provided in a dataset may contain one or more independent values. The independent values of a dataset may be referred to as “features,” and a collection of features may be referred to as a “feature space.” Additionally, datasets may contain corresponding dependent values. The dependent values may be the result or outcome associated with a set of independent values. In some examples, the dependent values may be referred to as “target values.” Although dependent values may be a necessary component of a dataset for certain algorithms, not all algorithms require a dataset with dependent values. Furthermore, both the independent and dependent values of the dataset may comprise either numerical, categorical, or text-based data.

While it may be true that machine learning model development is more successful with a larger dataset, it may also be the case that the whole dataset is not used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may comprise evaluating machine learning model performance according to whether the model is over-fit or under-fit. As it may be assumed that all datasets contain some level of error, it may be important to evaluate and optimize the machine learning model performance and associated model fit by means of model validation. In general, the variability in model fit (e.g.: whether a model is over-fit or under-fit) may be described by the “bias-variance trade-off.” As an example, a machine learning model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods comprise k-fold cross-validation, stratified k-fold cross-validation, bootstrapping, leave-one-out cross-validation, resubstitution, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may include the model error, wherein a selected set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning model. As such, algorithm hyperparameters may affect the computational intensity associated with developing a model from a specific dataset.

Machine learning algorithms, which may be capable of capturing the underlying relationships within a dataset, may be broken into different categories. One such category may comprise whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset comprises both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may comprise Neural Networks, K-Nearest Neighbors, Naïve Bayes, Decision Trees, Classification Trees, Regression Trees, Random Forests, Linear Regression, Support Vector Machines (SVM), Gradient Boosting Regression, Genetic Algorithm, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not comprise a dependent variable as the intended function of this type of algorithm is to identify one or more groupings or clusters within a dataset. In a non-limiting example, algorithms which may be utilized for unsupervised machine learning may comprise K-means clustering, K-means classification, Fuzzy C-Means, Gaussian Mixture, Hidden Markov Model, Neural Networks, and Hierarchical algorithms.

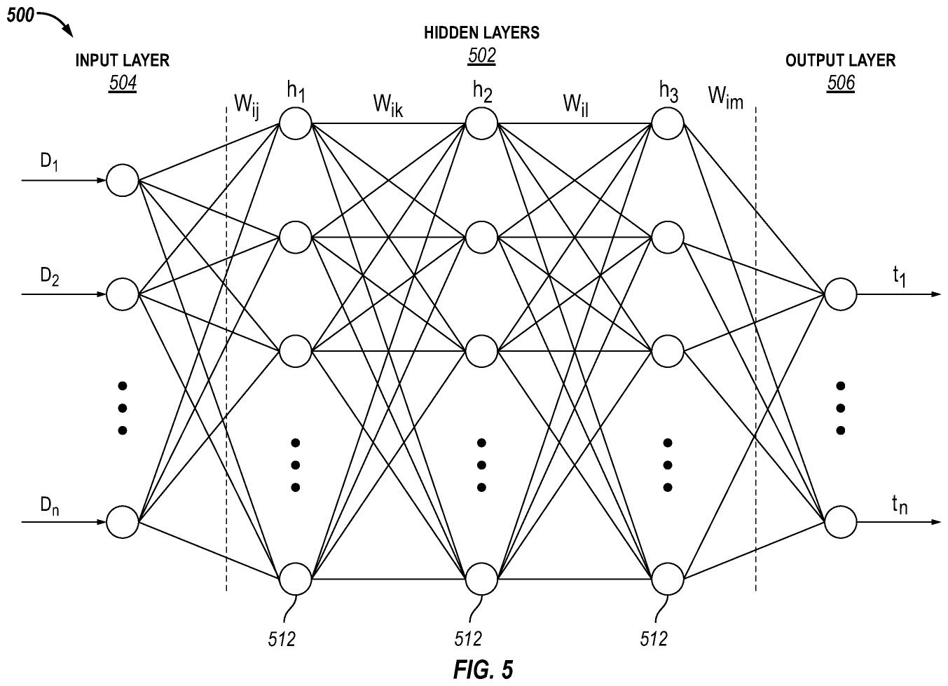

The machine learning models, using machine learning algorithms, may utilize transformer architecture of one or more neural network algorithms as illustrated in FIG. 8. Examples of machine learning algorithms that fall into the category of neural networks may comprise Perceptron, Multi-Layer Perceptron, Feed Forward, Radial Basis Network, Deep Feed Forward, Recurrent Neural Network, Long Term Memory, Short Term Memory, Deep Neural Network, Gated Recurrent Unit, Auto Encoder, Variational AE, Denoising AE, Sparse AE, Markov Chain, Hopfield Network, Boltzmann Machine, Restricted Boltzmann Machine, Deep Belief Network, Deep Convolutional Network, Deconvolutional Network, Deep Convolutional Inverse Graphics Network, Generative Adversarial Network, Liquid State Machine, Extreme Learning Machine, Echo State Network, Deep Residual Network, Kohonen Network, Support Vector Machine, and Neural Turing Machine. Neural network 500 of FIG. 5 may be utilized to draw a relationship between independent and dependent variables, or to identify relationships within a set of exclusively independent variables as described herein. Neural network 500 may be an artificial neural network with one or more hidden layers 502 between input layer 504 and output layer 506. As illustrated, input layer 504 may include multi-disciplinary datasets as described in the foregoing, whereas output layer 506 may include data which may further feed the model stack or may provide outputs used to populate a drilling program. As such, the outputs from neural network 500 may provide results which are directly included in the drilling program or may function as inputs to a subsequent model or series of models which may then provide results which may be included in the drilling program. Input data is taken by neurons 512 in first layer which then provide an output to the neurons 512 within next layer and so on which provides a final output in output layer 506. Each layer may have one or more neurons 512. The connection between two neurons 512 of successive layers may have an associated weight. The weight defines the influence of the input to the output for the next neuron 512 and eventually for the overall final output. The process of training the neural network may entail determining the suitable weights that produce a model capable of being utilized in a hybrid data generator to generate one or more drilling programs. Furthermore, building the machine learning model may be an iterative process which comprises a validation component and/or reinforcement learning, as previously mentioned. Once a model which meets one or more criteria for deployment, which in a non-limiting example may comprise achieving a certain level of accuracy, it may be incorporated into a hybrid data generator to generate one or more drilling programs. In some examples, the level of accuracy which meets the deployment criterion may range from about 50% to about 100%. Alternatively, the level of accuracy may range from about 50% to about 60%, about 60% to about 70%, about 70% to about 80%, about 80% to about 90%, or about 90% to about 100%. Finally, if the historical dataset, which may further comprise multi-disciplinary datasets, increases in size due to the acquisition of additional data, the model may be retrained to incorporate the learnings of the additional data. In some examples, data generated by a hybrid data generator may additionally be incorporated into the dataset to augment the training dataset.

The machine learning model described above may be further improved by incorporating prior knowledge into machine learning algorithms. For example, knowledge-based features such as physics principles, logic rules, simulation results, human feedback, may be utilized within the algorithm and a modified loss function that considers the underlying range of possible values provided by a scenario identification. The flexibility of combining data-driven and knowledge-based solutions provides an adequate framework for a more reliable cement bond evaluation.

As described above, a machine learning model states a specific problem for which there is training data. Training data may be fed into the machine learning algorithm, which delivers a solution using the methods and systems described above. Problems may typically be formulated as regression tasks where inputs X has to be mapped to outputs Y using candidate functions f. Training data is generated or collected and then processed by the machine learning algorithms, which try to approximate the unknown function F by different candidates f. The optimal solution f* is obtained by minimizing the cost function. In traditional approaches, knowledge is generally used in the machine learning model, mainly for training data preprocessing (e.g., labeling) or feature engineering. The information flow of informed machine learning comprises an additional prior knowledge integration. It thus may comprise of three added components in the ML workflow.

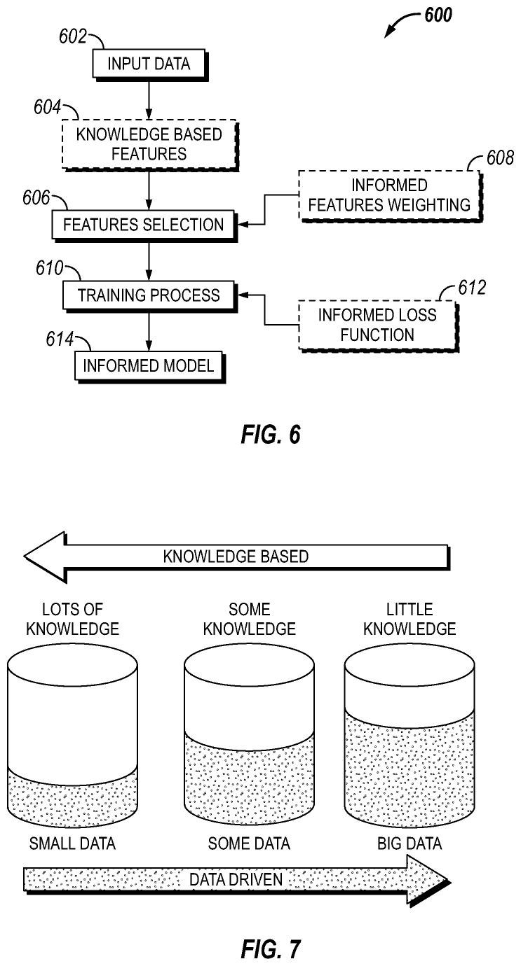

FIG. 6 illustrates a workflow 600 for an informed machine learning model. For the informed machine learning model, prior knowledge exists independently of the learning task and may be provided through logic rules, simulation results, knowledge graphs, and/or the like. The essence of informed machine learning model is that this prior knowledge is explicitly integrated into the machine learning model through interfaces defined by the knowledge representations. As illustrated in FIG. 6, the informed machine learning model may begin with input data in block 602. Input data of block 602 may comprise raw data collected from acoustic logging tool 100 (e.g., referring to FIG. 1). The raw data may comprise energy amplitudes within time intervals (i.e., time series). In other examples, input data may be simulated data that may be utilized to increase sample sizes. Input data may further be supplemented with knowledge based features in block 604.

In block 604, knowledge based features may be established to create an informed machine learning model. A number of approaches may be utilized in feature creation. In one example, an automated features engineering process is utilized. An automated features engineering process is defined as an algorithm that selects, combines, and transforms different variables (features) in such a way that increases the model performance. In examples, the algorithm may be a deep feature synthesis, which may use other non-physics-related variables, such as tubing/casing characteristics, inner and outer annulus composition and/or the like. Additional procedures may also be applied in this step, such as Principal Component Analysis (PCA) for dimensionality reduction. The second is extracting physics-based characteristics from the acoustic data using standard array processing methods like semblance, waveform coherence stacking, and waveform inversion. Multiple dimension input array data may be utilized as well. In examples, multiple dimension input array data may be time based, such as data from time slots within time intervals. Spatial based, such as receiver data with a different transmitter-to-receiver (T-R) spacings. Transformation based (i.e., time or spatial domains), such as sub-divided in time window's data transform output sub-bands like discrete frequency channels in a Fast Fourier Transform (FFT) spectrum output. Acoustic based, such as propagation parameters, amplitude, resonance frequencies, and modes (i.e., body wave versus head wave) that may be selected from monopole, dipole, quadrupole, and/or hexapole. Wave mode based, such as shear, compression, lamb, Ao mode, and/or the like. In another approach, physics-based knowledge that may be relevant for machine learning model building, such as tubing eccentricity, borehole fluid composition, previously mapped characteristics of the well, and/or the like. In other examples, mathematical concepts such as algebraic equations, differential equations, simulation results, spatial invariances, logic rules, knowledge graphs, probabilistic relations, and/or human feedback may be utilized. Once features are established, a selection and weighing of the features may be performed.

With continued reference to FIG. 6, the output from block 602 may be utilized as input for block 606. In block 606 a feature selection may be performed. In examples, a feature selection may comprise selecting a subset of relevant features for use in model construction. Feature selection in block 606 may be supplemented by block 608 in which informed features weighting may be performed. For example, features based on their confidence level and prior knowledge may be weighted. For example, in a random forest, the obtained features may be biased sampled towards more meaningful ones. Likewise, in Support Vector Machines (SVM) and regression, the values may be multiplied by a constant after features normalization. In standard ML processes where the amount of data is considered satisfactory, it is not advised to attribute weights to features. The machine learning algorithm determines which features are relevant based on the training process. However, in measurement operations for plug and abandonment operations, the minimum data required may not be satisfied. Thus, an informed machine learning model may be utilized using the methods and systems described. Within block 608 an information tuning parameter I may bias the machine learning model towards knowledge-based attributes. Information I may be defined as a modified version of Shannon's entropy from information theory:

$$I = 1 + {\sum }_{i}^{n} {w}_{i} {log}_{n} ( {w}_{i} ) \qquad ( 1 )$$

where n is the number of features and 0≤w₁<1 is the weight of the i-th feature and satisfies the relation:

$${\sum }_{i}^{n} {w}_{i} = 1 \qquad ( 2 )$$

Below discuss two extreme cases in a ML process. In one extreme case, there is not enough data for the ML training but a solid knowledge (information) about physics. In this case, information is maximum I =1 and therefore

$${\sum }_{i}^{n} {w}_{i} {log}_{n} ( {w}_{i} ) = 0 \qquad ( 3 )$$

This means only a physics-based feature is informative (wᵢ=1), and the standard physics-based analysis is retrieved. In a second extreme case, if there are lots of data and no knowledge, I=0 and hence

$${\sum }_{i}^{n} {w}_{i} {log}_{n} ( {w}_{i} ) = - 1 \qquad ( 4 )$$

The standard ML process is retrieved where all features have the same weight

$${w}_{i} = \frac{1}{n} .$$

The information/may be adjusted according to the data size and previous knowledge (0≤1≤1), i.e., it regulates the transition between data-driven and knowledge-based approaches as illustrated in FIG. 7.

Referring back to FIG. 6, the output from block 606, that has been altered from block 608, may be utilized as input in block 610 in a training process. A training process may comprise three steps. In a first step, data input in block 610 may be split into a train block and test block. In step two, performance between a training action and testing action may be utilized using a cost function. For this disclosure, an “action” may be defined as the use of computational resources and power to perform mathematical algorithms, equations, and/or the like to qualify, clean, enhance, update, and/or the like to improve recorded data that may comprise noise and other extraneous information within a data set. Actions may be performed on information handling system 144 (e.g., referring to FIG. 1). In step three, model parameters may be changed (hyperparameter tunning). Generally, each method has options, for example in neural networks, it is possible to change the number of hidden layers, units, learning rate, number of epochs, etc. These steps are repeated until an optimized accuracy is reached. Usually, k-fold cross-validation is used within the train/test data split. The performance may be evaluated using fl-score, accuracy, AROC curves, etc. For hyper-parameters optimization, there are several options, for example, grid or random search. The training process in block 610 may be altered by block 612 with an informed loss function.

An informed loss function may integrate prior knowledge into the loss function of the training process. In supervised ML, the loss function is determined as the difference between the actual and the predicted output for a single training example. In contrast, the average loss function for all the training examples is termed the cost function. A supervised ML process aims to obtain a model f* that minimizes the cost function, Eq. 3.

$$f * = arg {min}_{f} \{ {γ}_{k} {L}_{k} [ f ( {x}_{i} ) , {x}_{i} ) ] + {γ}_{l} {\sum }_{i} L [ f ( {x}_{i} , {y}_{i} ) ] + {γ}_{r} R ( f ) \} \qquad ( 5 )$$

The cost function is evaluated for each candidate model f, where x, is the input data, y, are the labels, L is the usual label-based loss, R is the regularization function, and Lₖ quantifies the violation of a given prior-knowledge. Parameters y₁, yᵣ, and yₖ determine the weights of each loss term. Similarly, to the informed feature weighting, the informed loss function may be adjusted by increasing y₁ (more data-driven) or yₖ (more knowledge-based). Predictions that do not agree with known constraints may be discarded or marked as suspicious so that results are consistent with prior knowledge. The informed loss function in block 612 may alter the training process in block 610.

The output of block 610 may form the informed machine learning model in block 614. In examples, the informed machine learning model may undergo testing and evaluation to determine if the information provided by the informed machine learning model is consistent with established knowledge. The informed machine learning model is an improvement over current machine learning models. For example, the informed machine learning model produces more reliable results. This is because prior knowledge may provide gaps and boundaries for the ML process, avoiding inadequate generalizations that produce misleading results. Additionally, the informed machine learning model creates data efficient algorithms. The amount of data needed to train a ML model depends on the complexity and the variety of scenarios in the analyzed system. This could be a limitation for ML, making its use unfeasible. However, if prior knowledge is provided, the model can be purposely biased toward this knowledge, decreasing the sample size needed for adequate generalization. The informed machine learning model may create faster training ML models. With fewer but more meaningful features, the time to train ML models is shortened since it decreases the number of possible combinations in the optimization process. Further, the informed machine learning model may be easier to interpret. Since many features are sustained in expert knowledge rather than solely on data, it helps to decrease the black box characteristic of standard ML approaches.

The systems and methods may include any of the various features disclosed herein, including one or more of the following statements. The systems and methods may include any of the various features disclosed herein, including one or more of the following statements.

Statement 1. A method may comprise providing one or more inputs to an information handling system, adjusting the one or more inputs with one or more knowledge based features on the information handling system, selecting one or more features from the one or more inputs by weighting informed features with the information handling system, forming a training process from the one or more features selected by utilizing an informed loss function with the information handling system, and forming an informed machine learning model that is used by the information handling system.

Statement 2. The method of statement 1, wherein the one or more knowledge based features comprise at least one type of data selected from an automated features engineering process or physics-based characteristics.

Statement 3. The method of statement 2, wherein the automated feature engineering process comprises at least one input selected from the group consisting of a deep feature synthesis, tubing/casing characteristics, or inner and outer annulus compositions.

Statement 4. The method of any previous statements 2 or 3, wherein the physics-based characteristics comprise at least one input selected from the group consisting of semblance, waveform coherence stacking, or waveform inversion.

Statement 5. The method of any previous statements 2-5, wherein the physics-based characteristics are chosen from multiple dimension input array.

Statement 6. The method of statement 5, wherein the multiple dimension input array is time based with data from one or more time slots within one or more time intervals.

Statement 7. The method of any previous statements 5 or 6, wherein the multiple dimension input array is spatial based with data from one or more time transmitter-to-receiver spacings.

Statement 8. The method of any previous statements 5-7, wherein the multiple dimension input array is transformation based with data from a discrete frequency channel in a Fast Fourier Transform spectrum output.

Statement 9. The method of any previous statements 5-8, wherein the multiple dimension input array is acoustic based with data from a monopole, a dipole, a quadrupole, or a hexapole.

Statement 10. The method of any previous statements 5-9, wherein the multiple dimension input array is wave mode based with data from a shear mode, a compression mode, or a lamb mode.

Statement 11. The method of any previous statements 2 or 3, wherein the one or more knowledge based features is selected from a tubing eccentricity, a borehole fluid composition, or a previously mapped characteristics of a wellbore.

Statement 12. The method of any previous statements 1 or 2, wherein the weighting informed features is performed by an operator based at least in part on prior knowledge.

Statement 13. The method of any previous statements 1, 2, or 12, wherein the informed loss function is

$$f * = arg {min}_{f} \{ {γ}_{k} {L}_{k} [ f ( {x}_{i} ) , {x}_{i} ) ] + {γ}_{l} {\sum }_{i} L [ f ( {x}_{i} , {y}_{i} ) ] + {γ}_{r} R ( f ) \} ,$$

where f* is a model, f is a candidate model, where x, is an input data, yᵢ are labels, L is label-based loss, R is a regularization function, and Lₖ quantifies a violation of a given prior-knowledge.

Statement 14. A computer-readable medium storing instructions which when processed by at least one processor perform a method for creating an informed machine learning model. This may be performed by adjusting one or more inputs into at least one processor with one or more knowledge based features, selecting one or more features from the one or more inputs by weighting informed features, forming a training process from the one or more features selected by utilizing an informed loss function, and forming the informed machine learning model from the training process.

Statement 15. The computer-readable medium of statement 14, wherein the one or more knowledge based features comprise at least one type of data selected from an automated feature engineering process or physics-based characteristics.

Statement 16. The computer-readable medium of statement 15, wherein the automated feature engineering process comprises at least one input selected from the group consisting of a deep feature synthesis, tubing/casing characteristics, or inner and outer annulus compositions.

Statement 17. The computer-readable medium of any previous statements 15 or 16,wherein the physics-based characteristics comprise at least one input selected from the group consisting of semblance, waveform coherence stacking, or waveform inversion.

Statement 18. The computer-readable medium of any previous statements 15-17, wherein the physics-based characteristics are chosen from multiple dimension input array.

Statement 19. The computer-readable medium of statement 18, wherein the multiple dimension input array is time based with data form one or more time slots within one or more time intervals.

Statement 20. The computer-readable medium of any previous statements 18 or 19,wherein the multiple dimension input array is spatial based with data from one or more time transmitter-to-receiver spacings.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
providing one or more inputs to an information handling system;
adjusting the one or more inputs with one or more knowledge based features on the information handling system;
selecting one or more features from the one or more inputs by weighting informed features with the information handling system;
forming a training process from the one or more features selected by utilizing an informed loss function with the information handling system; and
forming an informed machine learning model that is used by the information handling system.

2. The method of claim 1, wherein the one or more knowledge based features comprise at least one type of data selected from an automated features engineering process or physics-based characteristics.

3. The method of claim 2, wherein the automated feature engineering process comprises at least one input selected from the group consisting of a deep feature synthesis, tubing/casing characteristics, or inner and outer annulus compositions.

4. The method of claim 2, wherein the physics-based characteristics comprise at least one input selected from the group consisting of semblance, waveform coherence stacking, or waveform inversion.

5. The method of claim 2, wherein the physics-based characteristics are chosen from multiple dimension input array.

6. The method of claim 5, wherein the multiple dimension input array is time based with data from one or more time slots within one or more time intervals.

7. The method of claim 5, wherein the multiple dimension input array is spatial based with data from one or more time transmitter-to-receiver spacings.

8. The method of claim 5, wherein the multiple dimension input array is transformation based with data from a discrete frequency channel in a Fast Fourier Transform spectrum output.

9. The method of claim 5, wherein the multiple dimension input array is acoustic based with data from a monopole, a dipole, a quadrupole, or a hexapole.

10. The method of claim 5, wherein the multiple dimension input array is wave mode based with data from a shear mode, a compression mode, or a lamb mode.

11. The method of claim 2, wherein the one or more knowledge based features is selected from a tubing eccentricity, a borehole fluid composition, or a previously mapped characteristics of a wellbore.

12. The method of claim 1, wherein the weighting informed features is performed by an operator based at least in part on prior knowledge.

13. The method of claim 1, wherein the informed loss function is
$$f * = arg {min}_{f} \{ {γ}_{k} {L}_{k} [ f ( {x}_{i} ) , {x}_{i} ) ] + {γ}_{l} {\sum }_{i} L [ f ( {x}_{i} , {y}_{i} ) ] + {γ}_{r} R ( f ) \} ,$$
where f* is a model, f is a candidate model, where xi is an input data, yᵢ are labels, Lis label-based loss, R is a regularization function, and Lₖ quantifies a violation of a given prior-knowledge.

14. A computer-readable medium storing instructions which when processed by at least one processor perform a method for creating an informed machine learning model comprising:
adjusting one or more inputs into at least one processor with one or more knowledge based features;
selecting one or more features from the one or more inputs by weighting informed features;
forming a training process from the one or more features selected by utilizing an informed loss function; and
forming the informed machine learning model from the training process.

15. The computer-readable medium of claim 14, wherein the one or more knowledge based features comprise at least one type of data selected from an automated feature engineering process or physics-based characteristics.

16. The computer-readable medium of claim 15, wherein the automated feature engineering process comprises at least one input selected from the group consisting of a deep feature synthesis, tubing/casing characteristics, or inner and outer annulus compositions.

17. The computer-readable medium of claim 15, wherein the physics-based characteristics comprise at least one input selected from the group consisting of semblance, waveform coherence stacking, or waveform inversion.

18. The computer-readable medium of claim 15, wherein the physics-based characteristics are chosen from multiple dimension input array.

19. The computer-readable medium of claim 18, wherein the multiple dimension input array is time based with data form one or more time slots within one or more time intervals.

20. The computer-readable medium of claim 18, wherein the multiple dimension input array is spatial based with data from one or more time transmitter-to-receiver spacings.
